(19) United States
(12) Patent Application Publication
(10) Pub. No.: US 2018/0123867 A1
(43) Pub. Date: May 3, 2018

(54) AUTOMATIC NETWORK CONNECTION RECOVERY IN THE PRESENCE OF MULTIPLE NETWORK INTERFACES

(71) Applicant: Microsoft Technology Licensing, LLC, Redmond, WA (US)

(72) Inventors: Praveen BALASUBRAMANIAN, Seattle, WA (US); Sourav DAS, Seattle, WA (US)

(21) Appl. No.: 15/600,692

(22) Filed: May 19, 2017

Related U.S. Application Data
(60) Provisional application No. 62/415,393, filed on Oct. 31, 2016.

(51) Int. Cl. H04L 12/24

(52) U.S. Cl. CPC H04L 41/0654; H04L 65/80; H04L 41/147

(57) ABSTRACT

The disclosure enhances user experience associated with recovering network connectivity after connection failure. An acknowledgement failure is detected for a connection using a first route over a first network interface. When a path of the connection is found to be unreachable, a second route is identified as an alternative to the first route. When the second route is over the first network interface, the connection is moved to the second route. However, when the second route is over a second network interface, the connection is transitioned to the second route over the second network interface. The first route is marked dead when unreachable and moved paths of the first route exceed a threshold based on the total paths of the route. Identifying alternative routes and transitioning connections to routes on different network interfaces provides an efficient, improved user experience when recovering network connectivity.

### CROSS-REFERENCE TO RELATED APPLICATION

This application claims the benefit of U.S. Provisional Application No. 62/415,393, filed Oct. 31, 2016.

### BACKGROUND

Electronic devices, such as personal computers, laptops, mobile phones and the like are increasingly equipped with multiple network interfaces that enable network connection over a variety of network types and/or protocols. For instance, many mobile phones are equipped with network interfaces for communication via Wi-Fi networks, cellular networks, BLUETOOTH brand communication networks, etc. As connectivity to different types of networks changes based on time, location, and/or state of the network infrastructure, the capability of devices to transition between networks to maintain network performance becomes important for providing a satisfying user experience.

Some existing systems monitor connection quality to determine when to switch connections among routes through a single interface. For instance, a device may move a connection from one Wi-Fi router to another Wi-Fi router when connection through the first router is found to be poor. However, some of these existing systems are designed for single interface hosts, and do not work well for multi-homing scenarios.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method comprises detecting an acknowledgement failure for a connection using a first route over a first network interface and, in response to detecting the acknowledgement failure, incrementing a suspect reachability count of a path associated with the connection. The method further comprises identifying a second route as an alternative to the first route when the suspect reachability count of the path exceeds a suspect reachability threshold, moving the path to the identified second route and incrementing a moved path count of the first route when the identified second route is over the first network interface, and incrementing an unreachable path count of the first route when the identified second route is over the second network interface. The computerized method also comprises marking the first route as dead when a sum of the unreachable path count of the first route and the moved path count of the first route exceeds a bad path threshold, the bad path threshold based on a total path count associated with the first route, and transitioning the connection using the first route over the first network interface to use the second route when the second route is over the second network interface.

Many of the attendant features will be more readily appreciated as the same becomes better understood by reference to the following detailed description considered in connection with the accompanying drawings.

### BRIEF DESCRIPTION OF THE DRAWINGS

FIG. 1 is an exemplary block diagram illustrating a system including a computing device configured to form and communicate over network connections via network interfaces according to an embodiment;

FIG. 2 is an exemplary block diagram illustrating protocol layers of network connections via network interfaces according to an embodiment;

FIG. 3 is an exemplary flow chart illustrating operation of a computing device to recover a network connection over a first network interface by routing over a second network interface according to an embodiment;

FIG. 4 is an exemplary flow chart illustrating operation of a computing device to recover a network connection over a first network interface by routing over either the first network interface or a second network interface according to an embodiment; and

FIG. 5 illustrates a computing apparatus according to an embodiment as a functional block diagram.

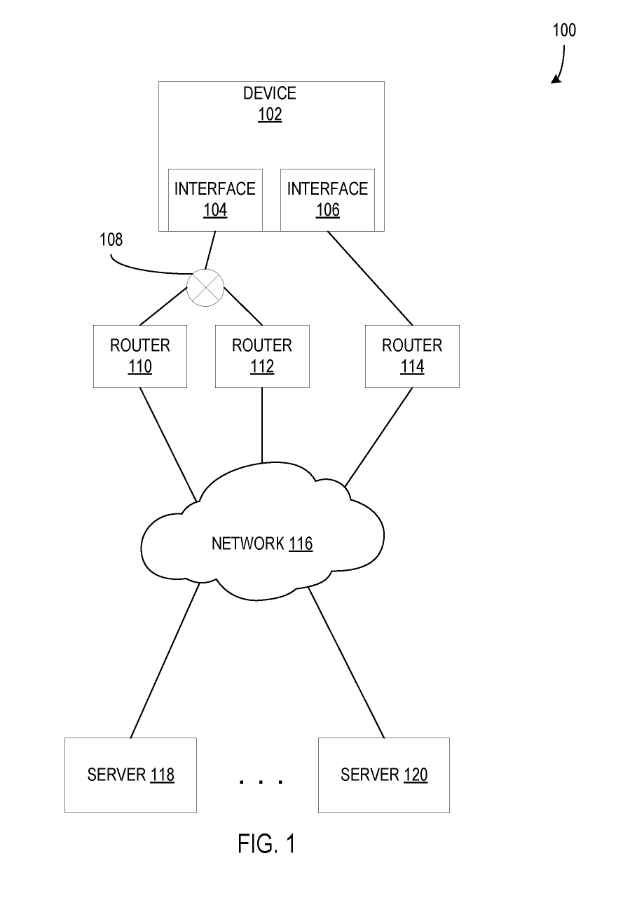

Corresponding reference characters indicate corresponding parts throughout the drawings. In FIGS. 1 to 5, the systems are illustrated as schematic drawings. The drawings may not be to scale.

### DETAILED DESCRIPTION

The computing devices described below are configured to enhance the user experience associated with maintaining network connectivity across multiple network interfaces. Dead routes and/or gateways are detected based on bad paths, which are a combination of moved paths and unreachable paths that could not be moved. When the number of bad paths exceeds a threshold, the associated route is considered dead and network traffic is routed and/or transitioned to other routes. The threshold for declaring a route ‘dead’ may be dynamic such that the threshold changes based on a total number of paths associated with the route, providing accurate dead gateway detection at a wide range of different total path counts (e.g., a route with very few paths has a higher threshold than a route with many paths, etc.). The dynamic threshold values may be fine-tuned over time based on collected feedback to continuously improve the accuracy of dead gateway detection and network connectivity performance.

Further, faster transitions of network connections between different network interfaces are provided using the dead gateway detection described herein. Alternative routes over different network interfaces are considered using the described devices and methods, resulting in failing connections being transitioned to routes on different network interfaces (e.g., tearing down or otherwise terminating the failing connections and causing new, similar connections to be formed over the different network interfaces, etc.) earlier than waiting for a ‘time out’ on the failed connections. New connections are routed over other network interfaces. The disclosure also identifies active paths and uses them for computing the bad path threshold, and passively probes dead routes and marks them undead if probing results in acknowledgement success. The user experience is improved by providing smoother, faster network connection transitions, reducing waiting time, and rendering temporary network failures less noticeable.

FIG. 1 illustrates an exemplary block diagram of a system 100 including a computing device 102 configured to form and communicate over network connections via network interfaces (e.g., network interfaces 104 and 106, etc.) according to an embodiment. The computing device 102 comprises network interfaces 104, 106 through which the computing device 102 connects to networks. Network interface 104 is connected through a switch 108 to routers 110, 112. Network interface 106 is connected to router 114.

Each of the routers 110, 112, 114 is connected to a network 116 (e.g., the Internet, a private intranet, etc.). Further, servers 118, 120 are connected to the network 116 such that they may communicate with each other, with the computing device 102, and/or with other computing devices, servers, or the like that may also be connected to the network 116.

The computing device 102 may comprise a personal computer, laptop, mobile phone, tablet, or the like. The network interfaces 104, 106 of the computing device 102 may be configured to operate on the same or different types of networks. For instance, interface 104 may be configured to operate on a Wi-Fi network while interface 106 may be configured to operate on a cellular network. Other network interface types are also contemplated, such as wired network interfaces (e.g., Ethernet network interfaces, etc.), BLUETOOTH brand communication network interfaces, satellite network interfaces, etc. In some examples, the interfaces 104, 106 are software manifestations of a hardware network interface used to send and receive packets.

Routers 110, 112, 114 are devices (e.g., computing devices, etc.) configured to route network traffic from devices over a network. As shown, the routers 110, 112, 114 may route network traffic to and from computing device 102 over the network 116. The computing device 102 may communicate with one or more of the servers 118, 120 via one or more of the routers 110, 112, 114. Router functionality is generally known by a person of ordinary skill in the art of computer networks, etc. and, as such, it should be understood that routers 110, 112, 114 behave in a typical manner. Further, it should be understood that, while the system 100 in FIG. 1 shows three routers, a switch, a network, servers, etc., as an example, other organizations or arrangements of networks and/or networking devices may be used without departing from the scope of aspects of the disclosure described herein.

The servers 118, 120 may also comprise computing devices. The servers 118, 120 may provide services to connected devices (e.g., computing device 102, etc.), such as serving websites for browsing on connected devices, serving video for streaming on connected devices, serving stored files via file transfer protocol (FTP), etc. While two servers 118, 120 are shown in system 100, it should be understood that more, fewer, or different servers may be included in a system without departing from the scope of aspects of the disclosure described herein.

The system described herein may be used in detection of dead routes/gateways and statuses thereof, as well as network connectivity recovery in networking applications. The system may employ dead gateway detection heuristics in a variety of network scenarios, including multi-homing scenarios (e.g., a device such as computing device 102 that has more than one interface (e.g., interfaces 104, 106), such as a Wi-Fi interface and a cellular interface, etc.) and single interface-multiple gateway scenarios (e.g. a device with a single interface connected to an external switch (e.g., switch 108) which is connected to two routers (e.g., routers 110, 112)). In an example, a connection manager uses the described gateway detection techniques as a means to decide when to transition connections from a bad interface to a good interface, and also when to transition back to a previously bad interface that has become a good interface. Further, the system may enable route change notifications to be provided to clients (e.g., applications subscribed to route change notifications) for route state transitions from ‘alive’ status to ‘dead’ status and vice versa. Alternatively or additionally, the system exposes a route state that may be queried (e.g., via a Get-NetRoute command).

Dead gateway detection (DGD) as described herein may be used by a system to find out whether external connectivity via a router is broken. External connectivity might be broken because the router itself has malfunctioned or it might be broken because an uplink router in the connection path has malfunctioned. For example, a cable service might be down, causing destination servers to not be reachable. DGD detects when such situations occur more quickly, which can enable the system to take measures to recover connectivity more quickly.

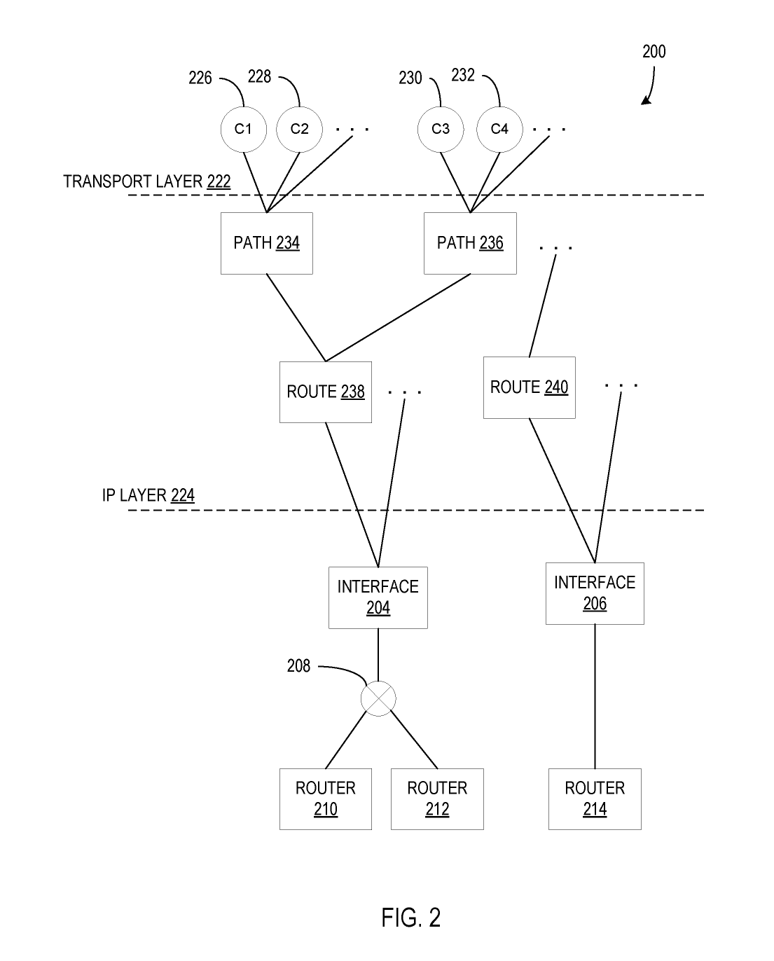

FIG. 2 is an exemplary block diagram 200 illustrating protocol layers (e.g., transport layer 222, Internet Protocol (IP) layer 224 (or other network protocol layer), etc.) of network connections via network interfaces according to an embodiment. The transport layer 222 includes connection objects 226, 228, 230, and 232. In an example, the transport layer 222 is layer 4, or L4, of the Transmission Control Protocol/Internet Protocol (TCP/IP) stack which implements connection protocols such as TCP, a connection-oriented protocol; User Datagram Protocol (UDP), a connectionless protocol that lacks acknowledgments; etc. Connection objects (e.g., connection objects 226-232, etc.) are software objects that enable connection to networks using one or more network protocols. A connection object may include a source IP address, a source port, a destination IP address, and/or a destination port, as well as an associated protocol (e.g., UDP, TCP, etc.). The connection objects may be created and/or used by applications and/or services on the computing device to access networks and/or other devices/servers on networks. Each connection object may be used to track a single connection on a network. A connection object may be associated with a path (e.g., paths 234, 236, etc.), which is a lower layer networking software object described below. To identify active paths, the disclosure identifies active connections. More, fewer, or different connection objects may be included in the transport layer in alternative examples without departing from the scope of the description herein.

The system makes use of TCP and/or other similar connection-oriented protocols which make use of acknowledgement messages to determine a connectivity state of the associated network connection. For instance, the transport layer 222 tracks each connection (e.g., connections 226-232, etc.) and may detect whether a connection is broken (e.g., suspect reachability indications, connections are re-transmitting data, connections are failing to receive acknowledgements, etc.) or if a connection is progressing successfully (e.g., confirmed reachability indications, connections are receiving acknowledgments, etc.) and send positive or negative notifications to the IP layer 224. The IP layer 224 controls the routing for all connections and tracks all paths (e.g., paths 234, 236, etc.) and/or routes (e.g., routes 238, 240, etc.) states and may use the notifications from the transport layer to determine the state of paths, gateways and/or routes as described below. Gateways handle traffic for a given route. For example, a home Wi-Fi router is the gateway for an Internet route from a computer on a Wi-Fi network.

The IP layer 224 includes paths 234, 236 and routes 238, 240. In an example, the IP layer 224 is Layer 3, or L3 of the TCP/IP stack, but other layers are contemplated within the scope of the description. It should be understood that the dead gateway detection process occurs primarily within L3, or the IP layer (e.g., IP layer 224, etc.) based on input from L4, or the transport layer (e.g., transport layer 222, etc.).

Paths (e.g., paths 234, 236, etc.) are software objects that denote one or more connections between a source and destination via a route (or gateway). Multiple connection objects may be associated with a path object. In some examples, a path is a tuple of source IP address and destination IP address, but no port information. Additionally, a path object may include path related information such as a maximum transmission unit (MTU) of the path and/or reachability of the path. Further, the IP layer 224 or a path object may track reachability data using a suspect reachability count or value associated with the path. The suspect reachability count or value of a path may indicate a current connectivity status of the path and/or connections that are associated with the path. For instance, if the suspect reachability count of a path is high, it indicates that the destination of the path is more likely to be unreachable than if the suspect reachability count of the path were low.

Routes (e.g., routes 238, 240, etc.) are software objects that store information on how to route data to a destination, such as information regarding which gateway(s) (e.g., routers, etc.) to use to reach a destination. A route object may be associated with multiple path objects and may include routing information for transmitting and receiving data via at least an interface (e.g., interfaces 204, 206, etc.) and/or a router (e.g., routers 210, 212, 214, etc.). For instance, a route may include a destination prefix, an interface identifier, a gateway identifier, and/or a route metric (a value that indicates a preference of the route and may be assigned based on link speed or other performance data points). Default route examples are shown below. The general functionality of route objects is well-understood by a person of ordinary skill in the art of computer networking.
Destination Prefix 0.0.0.0/0->Gateway1, Interface 1, Route Metric 10
Destination Prefix 0.0.0.0/0->Gateway2, Interface 2, Route Metric 20

In some examples, the IP layer 224 or route objects therein include data for tracking bad paths associated with the routes to determine a connectivity status of the routes. For instance, a route object may include a total path count (a value representing a quantity of paths associated with or routing through the route object), a moved path count (a value representing a quantity of paths that have been found to be unreachable and have been moved from the route object to another route object), and/or an unreachable path count (a value representing a quantity of paths routing through the route that have been found to be unreachable but cannot be moved). Each of the total path count, moved path count, and unreachable path count may be based on defined time intervals. For instance, total path count may be based on a quantity of paths that have been active within a time interval (e.g., a path may be active if one or more active connections have used the path within the time interval, etc.). While the described time interval is used to identify active paths in this case, in alternative examples, active paths may be identified through other methods. Moved path count and unreachable path count may be based on a quantity of paths that have been moved or found to be unreachable within time intervals. The total path count, moved path count, and unreachable path count may be based on only connection-oriented protocol paths in some examples. Further, a route object may include a status indicator that indicates whether the route object is considered “alive” (the route is considered to provide sufficient connection quality) or “dead” (the route is considered to provide insufficient connection quality). Route objects that are alive may be treated differently than route objects that are dead with respect to routing of network traffic.

It should be understood that for the purpose of this description the interfaces 204, 206, switch 208, and routers 210, 212, 214 operate in substantially the same manner as the equivalent interfaces 104, 106, switch 108, and routers 110, 112,114 of FIG. 1 above.

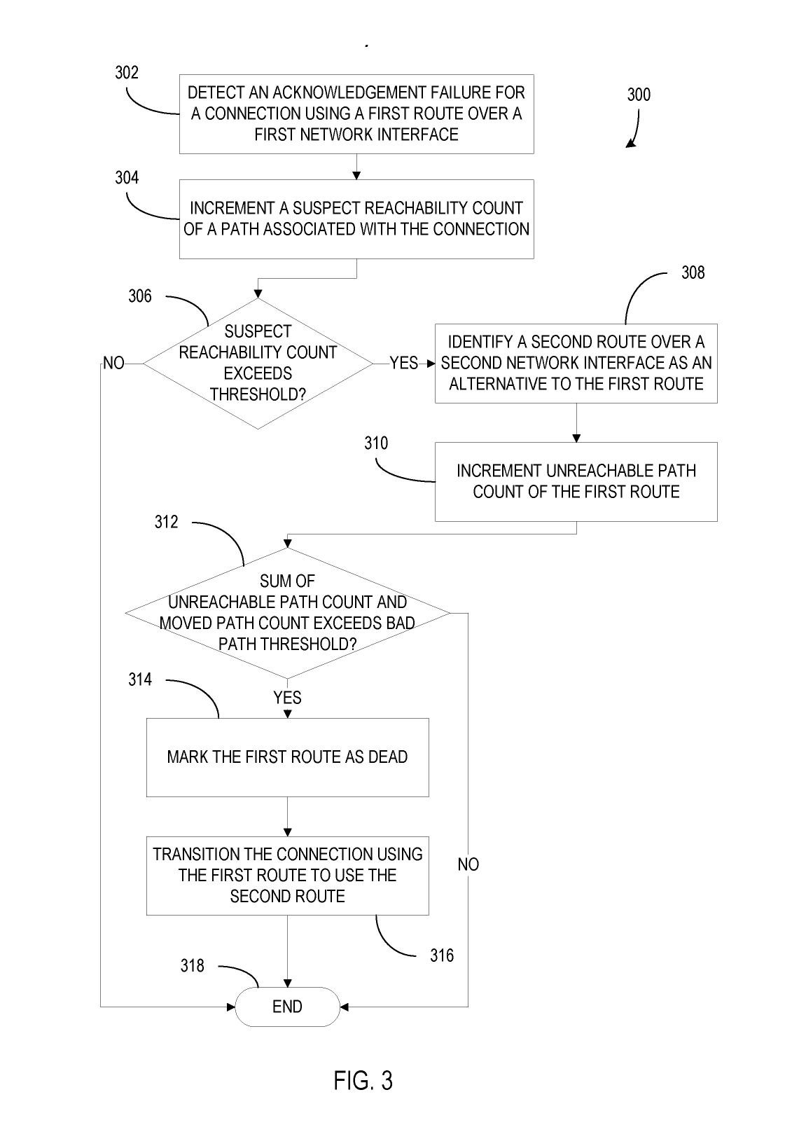

FIG. 3 is an exemplary flow chart 300 illustrating operation of a computing device (e.g., computing device 102, etc.) to recover a network connection over a first network interface (e.g., interfaces 104, 106, 204, 206, etc.) by routing the network connection over a second network interface (e.g., interfaces 104, 106, 204, 206, etc.) according to an embodiment. At 302, an acknowledgement failure is detected for a first connection (e.g., connection objects 226-232, etc.) using a first route (e.g., routes 238, 240, etc.) over a first network interface (e.g., interfaces 104, 106, 204, 206, etc.). For instance, when the number of consecutive re-transmissions (e.g., as a result of sending a packet and not receiving an acknowledgement) for a particular connection or connections (e.g., connections 226-232, etc.) at the transport layer 222 exceeds a defined threshold, the connection and/or transport layer may consider it an acknowledgement failure. The threshold may include, for instance, a quantity of consecutive or contemporaneous re-transmissions (e.g., an acknowledgement failure may occur when there are two re-transmissions from two different connections within a time-out timespan of one minute (or other defined timespan), etc.). In some examples, acknowledgement failures occur only in association with connection-oriented protocol connections, such as TCP connections, and not with connectionless protocols such as UDP.

Alternatively, or additionally, applications, including applications using connectionless protocols like UDP, may provide indications of acknowledgement failures that may be used by the systems described herein in identifying unreachable paths, dead routes, and the like. For instance, an application that uses UDP may detect a lack of response to sent requests or messages outside of UDP itself, register the lack of response as an acknowledgement failure, and send an indication of the failure to the IP layer for use in dead gateway detection.

As a result of the detected acknowledgement failure, at 304, a suspect reachability count of a path associated with the connection is incremented. For example, the transport layer may send a suspect reachability notification (negative notification) for the connection to the IP layer 224. At the IP layer 224, upon receiving a suspect reachability notification for a connection, a suspect reachability count for the associated path (e.g., paths 234, 236, etc.) is incremented.

If, at 306, the suspect reachability count exceeds a threshold, the path is considered unreachable, meaning that the connectivity between the source and destination of the path through the route is broken or of insufficient quality. The threshold may be defined for a time period within which the suspect reachability notifications must be received. For instance, if the suspect reachability threshold is 50 and the defined time period is 30 seconds, a path that receives 50 or more suspect reachability notifications within the most recent 30 second time interval would be considered unreachable. The system may decrement the suspect reachability count of a path when the notifications that caused the count to be incremented become older than the defined time period (e.g., when the time period is 30 seconds, the system may decrement the suspect reachability count for notifications received as those notifications age out or otherwise become older than 30 seconds).

In the case of a path being considered unreachable, at 308, the system identifies a second route over a second network interface as an alternative to the first route. For instance, identifying the second route may include identifying that the second route has the same or a similar destination prefix as the current route such that the traffic being routed over the first route can reach the correct destination if transitioned over to the second route. The unreachable path cannot be moved to the second route because the second network interface has a different source address than the first network interface and the source address of a connection cannot be changed. However, at 310, an unreachable path count is incremented on the route to track the connectivity status of the route. The unreachable path count of the route represents the paths associated with the route that are considered unreachable and that cannot be moved to another route on the same network interface as the first route. For instance, if path 234 is found to be unreachable when routed through route 238 and the only other available route is route 240, which uses interface 206 instead of 204, the path 234 cannot be moved to route 240, as the interfaces 204 and 206 have differing source addresses. However, the unreachable path count of route 238 may be incremented to track the unreachability of path 234. Alternatively, if the suspect reachability count of the path does not exceed the threshold, the process ends at 318.

In addition to the unreachable path count, the route may include a bad path count of a route, which includes the combination of a moved path count (paths that were found to be unreachable on the route and for which an alternative route was found over the same network interface) and the unreachable path count of the route. The bad path count represents the number of paths on the route that are or were experiencing connectivity issues and/or for which the system has received negative notifications (such as suspect reachability notifications, etc.). In some examples, the bad path count, unreachable path count, and/or moved path count are based on a recent time interval, such that bad paths detected within the time interval are included in the count(s). However, other ways of determining active paths are operable with the disclosure.

If the sum of the unreachable path count and the moved path count of the route (e.g., the bad path count, etc.) exceeds a bad path threshold at 312, the route is marked dead at 314. In an example, the bad path threshold includes a maximum percentage of bad paths on a route. The threshold may be based upon the total number of paths using that route (e.g., the sample size). For instance, the greater the total number of paths on the route, the lower the threshold may be set. In an example, an initial set of threshold values are defined below. Telemetry and feedback from consumers of dead gateway notifications may be used to fine-tune the thresholds over time. Table 1 features an example of initial thresholds that may be used, although other thresholds are contemplated.

TABLE 1

| | |
|---|---|
| Total Path Number | Bad Path Threshold Percentage |

| | | |
|---|---|---|
| >=10,000 | paths | 5% |
| 1000-9,999 | paths | 15% |
| 500-999 | paths | 20% |
| 100-499 | paths | 40% |
| 50-99 | paths | 50% |
| 10-49 | paths | 75% |
| 5-9 | paths | 100% |
| 0-4 | paths | N/A |

The example of Table 1 shows that if there are as high as 10000 paths on a route and 5% (500) of the paths are bad, that is enough to suspect that the route is dead. Alternatively, if there are as few as 5 paths on a route, 100% (5) of the paths need to be unreachable to suspect that the route is dead. If there are fewer than 5 paths, even all paths failing may not be sufficient to suspect that the route is dead because, for example, of the possibility that all the destination servers for the paths may have failed. It should be understood that the above values are exemplary and that other values may be used in other examples.

In an example, a percentage of bad paths of the route is calculated based on the actual bad path count of the route (e.g., the sum of the moved path count and the unreachable path count) and the original number of paths on the route, taking into account the paths that were originally on the route but have been moved (e.g., the sum of the current path count of the route and the moved path count of the route). Below is exemplary code for setting a route to ‘dead’ status when the percentage of bad paths meets or exceeds a threshold, although other code is contemplated.

```
TotalPaths = OldRoute−>PathCount + OldRoute−>MovedPathCount;
BadPaths = OldRoute−>MovedPathCount + OldRoute−>UnreachablePathCount;
if ((BadPaths * 100 / TotalPaths) >=
  IppGetDGDFailedPathThreshold(TotalPaths)) {
  RouteDead = TRUE;
}
```

As a result of marking a default route dead, the system may automatically begin routing network traffic over an alternative default route because the system prefers a non-dead default route to a dead default route.

Marking a route dead may also cause a notification to be sent to other components in the system, such as a connection manager. The other components may respond and/or react to the dead route notification. For instance, on a mobile device upon receiving dead route notification for the Wi-Fi router, the connection manager can turn off the Wi-Fi interface, tear down the existing connections on Wi-Fi interface and/or route all future connections over the cellular interface. In an alternative example, the TCP/IP stack routes new connections to an alternative route automatically, without involving the connection manager, when the first route is marked dead.

Alternatively, or additionally, the total path count, bad path count, moved path count, and/or unreachable path count of a route may be exposed to external components. The exposed path counts used by TCP/IP to set a route to ‘dead’ status may be used by the connection manager or other external component, application, operating system, or the like as a measure of confidence of badness or goodness of a gateway/interface.

At 316, the connection is transitioned to the identified second route over the second network interface. It should be understood that, because the second route is over the second network interface and the second network interface uses a different source address than the first network interface, transitioning the connection to the second route on the second network interface is not moving the connection to the second route. Rather, “transitioning” the connection may include tearing down or ending the connection over the first route and creating a new, similar connection over the second route to resume the activity of the torn down connection. In an example, transitioning a connection to another route on a different network interface does not happen in the IP layer specifically, but rather it must be executed by an application, connection manager, etc. outside of the IP layer. For instance, upon receiving a notification that a route is ‘dead’, a connection manager tears down the connection and any other connections over the ‘dead’ route/interface and rebuilds or creates similar connections for the second route over the second network interface (e.g., cellular, etc.). Rather than waiting for multiple retries and/or a ‘timeout’ indication as is done in some existing systems, applications using the torn down connections may receive ‘abort’ notifications with the present disclosure and transition to connections over the second route and/or second interface more quickly. After the connection is transitioned to the second route, the process ends at 318.

If the sum of the unreachable path count and the moved path count of the route (e.g., the bad path count, etc.) does not exceed the bad path threshold at 312, the process ends at 318.

In some examples, an unreachable connection is not transitioned to use a second route because, after the first route is marked ‘dead’, there is no application, connection manager, or the like that is configured to rebuild or create similar connections to make use of the second route.

In an alternative example, the path is already considered or flagged as unreachable upon detecting the acknowledgement failure at 302. In that case, the process may continue by transitioning the connection on the first route to use the second route at 316, as described above.

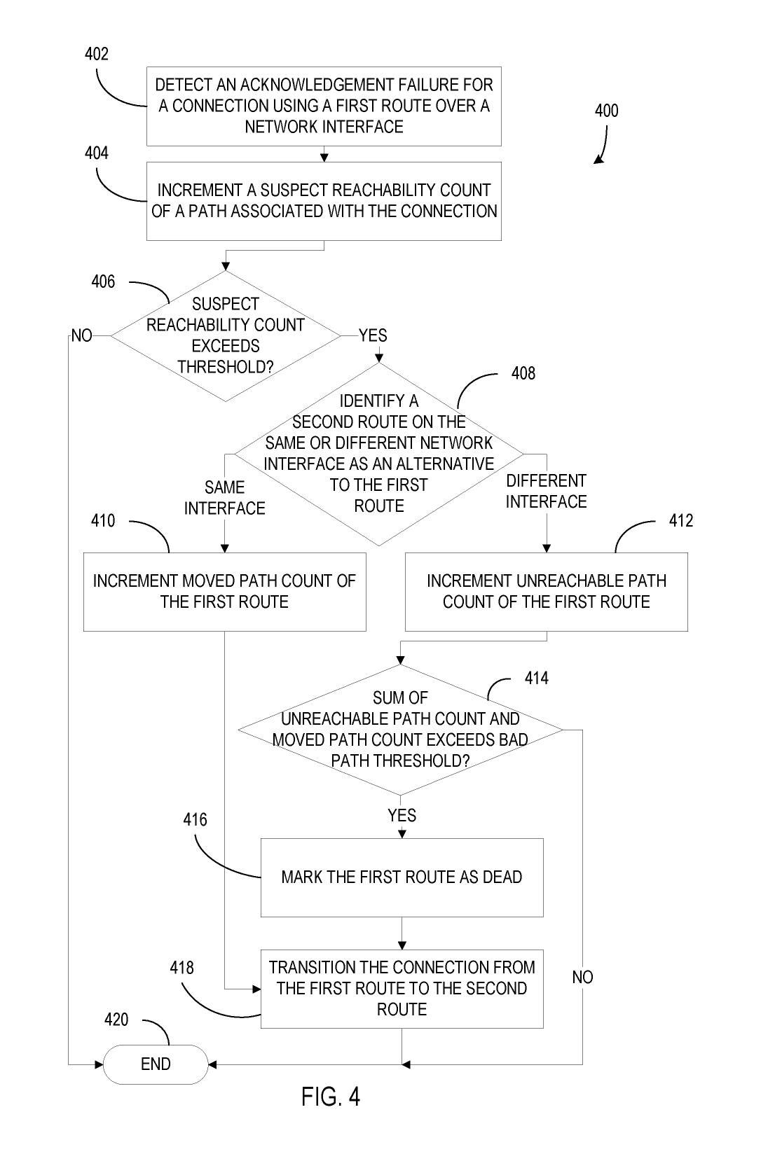

FIG. 4 is an exemplary flow chart 400 illustrating operation of a computing device (e.g., computing device 102, etc.) to recover a network connection over a first network interface by routing over either the first network interface or a second network interface according to an embodiment. At 402, an acknowledgement failure is detected for a first connection (e.g., connection objects 226-232, etc.) using a first route (e.g., routes 238, 240, etc.) over a first network interface (e.g., interfaces 104, 106, 204, 206, etc.) as described above with respect to 302 of FIG. 3.

At 404, a suspect reachability count of a path associated with the connection is incremented. If, at 406, the suspect reachability count exceeds a threshold, the path is considered unreachable, meaning that the connectivity between the source and destination of the path through the route is broken. It should be understood that 404 and 406 are substantially similar to 304 and 306 of FIG. 3 as described above.

When the path is considered unreachable at 406, the system identifies, at 408, a second route as an alternative to the first route. The identified second route may be over the same interface as the first route or over a different interface. If the alternative second route is on the same interface as the first route (e.g., the source address is the same, etc.), the unreachable path may be moved to the alternate route/gateway, so a ‘moved path count’ may be incremented at on the first route for tracking the connectivity status of the first route at 410 and the path is transitioned (moved, in this case) to the alternate route/gateway at 418 as described below. For instance, referring again to FIG. 2, if path 234 is found to be unreachable when routed through route 238 and a second route through interface 204 is available, path 234 may be moved to the second route and the ‘moved path count’ of route 238 may be incremented.

When the alternative second route identified at 408 is on a different interface than the first route, the unreachable path cannot be moved but, at 412, an ‘unreachable path count’ is incremented on the first route to track the connectivity status of the first route, as described above with respect to 310 of FIG. 3.

Alternatively, if the suspect reachability count of the path does not exceed the threshold at 406, the process ends at 420.

If the sum of the unreachable path count and the moved path count of the route (e.g., the bad path count, etc.) exceeds a bad path threshold at 414, the route is marked dead at 416. In an example, the bad path threshold includes a maximum percentage of bad paths on a route. The threshold may be based upon the total number of paths using that route (e.g., the sample size) as described above with respect to FIG. 3.

At 418, the connection is transitioned to using the identified second route. When the second route is over the same interface as the first route, the connection/path may be moved or rerouted over the second route while maintaining the same source address. However, when the second route is over a different interface than the first route, the connection/path must be transitioned to the second route as described above with respect to 316 of FIG. 3. That is, the connection is terminated. The connection/path is torn down, and rebuilt or otherwise created by a connection manager or other application, etc. After the connection is transitioned to the second route, the process ends at 420.

If the sum of the unreachable path count and the moved path count of the route (e.g., the bad path count, etc.) does not exceed the bad path threshold at 414, the connection associated with the unreachable path is transitioned from the first route to the identified alternative second route at 418. Then, the process ends at 420.

In an alternative example, when no alternative routes are found at 308 or 408, for instance, the process is not executed because there is nothing that can be done if the system has only one usable route, even if that route is found to be dead.

Upon receiving a suspect path reachability indication from the transport layer (e.g., transport layer 222, etc.) for a path, an exemplary sequence of operations may be executed by the IP layer (e.g., IP layer 224, etc.) as described below.

| | |
|---|---|
| 1. | If the number of ‘Suspect reachability’ notifications in THRESHOLD_{TimeInterval} |

< THRESHOLD_{SuspectReachabilityCount} then end the sequence.

| | |
|---|---|
| 2. | If Path−>IsReachable == FALSE (if the path is already unreachable) then |

end the sequence.

| | |
|---|---|
| 3. | Detect if there are alternate default routes/gateways on the system. If there |

are no such routes available, then end the sequence.

| | |
|---|---|
| 4. | Update Path Info: |

a. Path−>IsReachable = FALSE (mark the path as unreachable)

| | |
|---|---|
| 5. | Update Route Info: |

If an alternate gateway/route on same interface exists:

| | |
|---|---|
| a. | Path−>Route−>MovedPathCount++ (increment the moved path counter on |

old route)

| | |
|---|---|
| b. | Path−>IsReachable = TRUE (set the path to ‘reachable’ status) |

c. Path−>Route−>TotalPathCount-- (Decrement the total path counter on old
route)

| | |
|---|---|
| d. | Path−>Route = New Route (set path−>route to the new route) |
| e. | Path−>Route−>TotalPathCount++ (Increment the total path counter on |

```
new route)
  Else if the alternate gateway is on another interface:
  Path−>Route−>UnreachablePathCount++ (increment the unreachable path counter
on the path−>route)
```

| | |
|---|---|
| 6. | Use the following heuristics to mark the route as dead: |
| | TotalPaths = OldRoute−>PathCount + OldRoute−>MovedPathCount |
| | BadPaths = OldRoute−>MovedPathCount + |
| | OldRoute−>UnreachablePathCount; |
| | If ((BadPaths * 100 / TotalPaths) > GetBadPathThreshold(Tota/Paths)) |
| | Path−>Route−>Dead = TRUE (set path−>route to ‘dead’ status) |
| | Send Route change notification (indicating traffic to be routed |
| | through another route) |

### Additional Examples

In an example, upon receiving acknowledgments for a particular connection at the transport layer, the transport layer may send a confirm reachability indication (or other positive notification) for the connection to the IP layer. This notification may be sent whenever an acknowledgement is received for a connection. At the IP layer, upon receiving a confirm reachability notification from the transport layer, all connectivity tracking counters associated with the connection's path (e.g. suspect reachability count, etc.) and the path's route (e.g. moved path count, unreachable path count, etc.) can be cleared because a single positive notification is a strong indicator that the gateway/route is not dead. For instance, upon getting a confirm reachability indication from the transport layer, the system may clear the state of the path and/or route as shown in the exemplary pseudo-code below:

```
  Path−>IsReachable = TRUE. (set path to ‘reachable’ status)
  Path−>Route−>Dead = FALSE (set path−>route to ‘alive’ status)
  Path−>Route−>UnreachablePathCount = 0 (reset unreachable path counter
of path−>route to zero)
  Path−>Route−>MovedPathCount = 0 (reset moved path counter of path-
>route to zero)
```

In another example, the system may recover routes set to ‘dead’ status. Dead routes may be probed at defined intervals (e.g., every five minutes, etc.) and/or due to detected system states. For example, some new connections are diverted over the dead routes to probe for connectivity during the probe interval. The number of connections routed over the dead routes during the probe interval may be limited to a maximum probe connection threshold (e.g., DEAD_ROUTE_PROBE_MAX_TRAFFIC_COUNT, etc.). This limit prevents the system from sending excessive traffic over the dead routes. Further, in some examples, only new connection attempts are routed over the dead routes during the probing. In an example, a threshold value of a maximum of ten connection attempts per probe interval may be used. Collected data and/or telemetry may be used by the system to adjust and/or tune this threshold value.

Further, probed routes may be tested in parallel. For instance, different connection attempts may be attempted on multiple IP addresses at the same time to shorten the time required to recover the dead routes. For instance, the system may include an application programming interface (API) called ConnectByName. Instead of connecting by IP address, the system recommends that applications connect using a domain name. The system makes a domain name system (DNS) lookup, and the DNS lookup returns several IP addresses. The system may try the several IP addresses in parallel. For instance, if four IP addresses are returned, the system may try two of the four IP addresses in parallel. Each IP address may also be tried over different interfaces. If the default route/gateway on a first interface is considered dead but is being probed, and the default route on a second interface is currently functional, the system may try the default routes on the first interface and on the second interface in parallel. If the route on the first interface is still dead, the route on the second interface will succeed, preserving the user experience even if some connections fail. However, if trying the route on the first interface reveals that the route is no longer dead and the first interface is the preferred interface, the system may clear the ‘dead’ state from the route on the first interface and begin using it as the preferred route.

Alternatively, or additionally, a route change notification may be triggered when a route's state changes between dead and alive. A notification may further be triggered when any route gets into the probe state. For instance, the existing IP Helper Application Programming Interface (IPHLPAPI)—NotifyRouteChange2 function may be used to register for these notifications, although other APIs are contemplated. Applications, services, etc. may register to receive route change notifications via an API and then respond when the notifications are received. A Get-NetRoute call may further cause a return or display of route state (e.g., ‘dead’, ‘probe’, ‘alive’, etc.), providing an additional method of accessing a connectivity state of a route.

The system may make use of two or more interfaces simultaneously, with some interfaces being preferred over others. Interface preference may be based on link speed, cost, or the like. When a first interface is preferred over a second interface, the system defaults to routing connections over the first interface. However, if routes over the first interface are considered ‘dead’, then the second interface may be used. When the second interface is in use and routes over the preferred first interface are then found to be ‘alive’ again, the system may transition connections back from the second interface to the first interface. For instance, a Wi-Fi interface may be preferred over a cellular interface due to performance, cost, or other factors.

In an example, a user interface control (e.g., a checkbox) may be provided to enable and/or disable dead gateway detection. In other examples, Set-NetIpv4protocol, Set-NetIpv6protocol, or other commands may be used to enable/disable this functionality.

In a further example, an API (e.g., the ConnectByName API, etc.) may make use of the multiple network interfaces of the system described herein. The API may tell applications to connect to a destination by domain name rather than IP address, retrieve ranges of IP addresses associated with the domain name, and attempt to connect to the IP addresses of the range in parallel using multiple network interfaces. For instance, an application may try two IP addresses at the same time using a Wi-Fi network interface and a cellular interface, which may cut the time to form or recover a connection in half. Additionally or alternatively, the system may attempt to connect to two IP addresses in parallel using different connections on the same network interface to reduce impact to the user experience.

In an alternative example, two routers may be used at the same time. In still another alternative example, there may be more than two routers, and a computing device may select two or more of those routers for simultaneous use. Routers may be selected based on an order in which the routers are detected, a priority order defined by a user, a priority order based on past performance of the routers, etc.

In a further alternative example, the unreachable path count and moved path count of a route may be compared against independent thresholds in order to determine whether a route is dead. For instance, dynamic threshold values may be defined for the unreachable path count of a route as a percentage of the total path count of the route and for the moved path count of a route as a percentage of the total path count. If one or both of the thresholds are exceeded, the associated route may be marked dead. See the exemplary pseudo-code below demonstrating a heuristic to mark a route dead.

```
TotalPaths = OldRoute−>PathCount + OldRoute−>MovedPathCount;
if ((OldRoute−>MovedPathCount * 100 / TotalPaths) >=
GetDGDMovedPathThreshold(TotalPaths) OR (OldRoute-
>UnreachablePathCount * 100 / TotalPaths) >=
  GetDGDUnreachablePathThreshold(TotalPaths)) {
    RouteDead = TRUE;
}
```

### Example Scenarios

Aspects of the disclosure enables various scenarios, such as next described.

A user's computing device is connected to a Wi-Fi network at home. The user leaves home with the computing device, exiting the range of the Wi-Fi network. The computing device operates as described herein to transition connections that were over the Wi-Fi network, and have now failed, to connections on a cellular network.

A user's computing device is connected to a Wi-Fi network at home. The Wi-Fi network goes down. The computing device operates as described herein to transition connections over the Wi-Fi network that failed to connections on a cellular network. Then the Wi-Fi network comes back online. The computing device operates to recover by switching back to connections on the Wi-Fi network.

A user's computing device is connected to an Ethernet network at home via a docking station. The user undocks the computing device, breaking the connections to the Ethernet network. The computing device operates as described herein to transition connections that were over the Ethernet network, and have now failed, to connections on a Wi-Fi network.

In all of these examples, the computing device performs the transition of the connections quickly and efficiently. For example, if Wi-Fi connections are experiencing connectivity issues, the computing device switches to an alternate route/interface immediately, causing connections to be torn down and new connections to be formed as necessary rather than waiting for a reconnection through the Wi-Fi route/interface. By avoiding waiting for connections to time out before concluding that the route may be dead, the user experience is improved.

### Exemplary Operating Environment

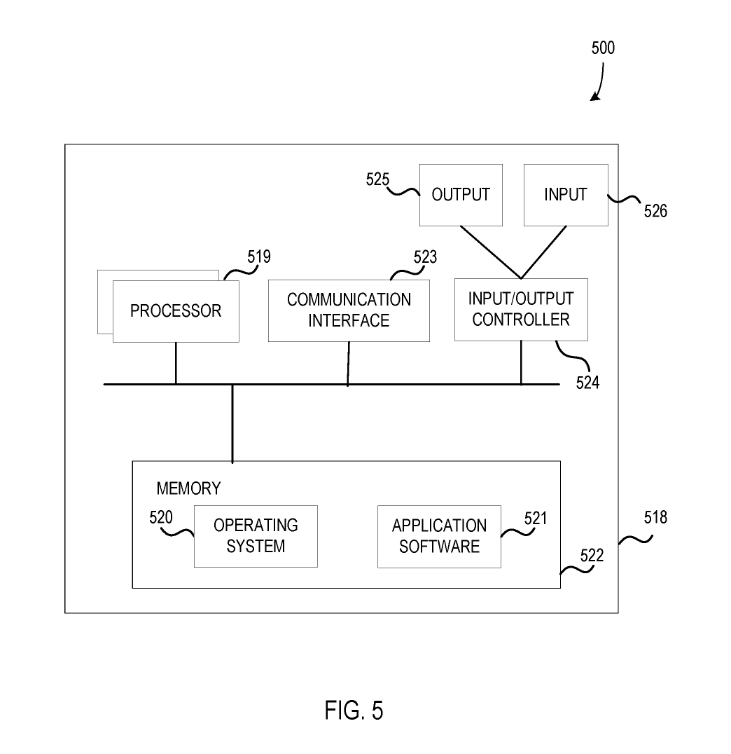

The present disclosure is operable with a computing apparatus according to an embodiment as a functional block diagram 500 in FIG. 5. In an embodiment, components of a computing apparatus 518 may be implemented as a part of an electronic device according to one or more embodiments described in this specification. The computing apparatus 518 comprises one or more processors 519 which may be microprocessors, controllers or any other suitable type of processors for processing computer executable instructions to control the operation of the electronic device. Platform software comprising an operating system 520 or any other suitable platform software may be provided on the apparatus 518 to enable application software 521 to be executed on the device. According to an embodiment, the identification of dead routes and transitioning between routes and/or interfaces may be accomplished by software.

Computer executable instructions may be provided using any computer-readable media that are accessible by the computing apparatus 518. Computer-readable media may include, for example, computer storage media such as a memory 522 and communications media. Computer storage media, such as a memory 522, include volatile and non-volatile, removable and non-removable media implemented in any method or technology for storage of information such as computer readable instructions, data structures, program modules or the like. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 522) is shown within the computing apparatus 518, it will be appreciated by a person skilled in the art, that the storage may be distributed or located remotely and accessed via a network or other communication link (e.g. using a communication interface 523).

The computing apparatus 518 may comprise an input/output controller 524 configured to output information to one or more output devices 525, for example a display or a speaker, which may be separate from or integral to the electronic device. The input/output controller 524 may also be configured to receive and process an input from one or more input devices 526, for example, a keyboard, a microphone or a touchpad. In one embodiment, the output device 525 may also act as the input device. An example of such a device may be a touch sensitive display. The input/output controller 524 may also output data to devices other than the output device, e.g. a locally connected printing device. In some embodiments, a user 527 may provide input to the input device(s) 526 and/or receive output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

Although some of the present embodiments may be described and illustrated as being implemented in a smartphone, a mobile phone, or a tablet computer, these are only examples of a device and not a limitation. As those skilled in the art will appreciate, the present embodiments are suitable for application in a variety of different types of devices, such as portable and mobile devices, for example, in laptop computers, tablet computers, game consoles or game controllers, various wearable devices, etc.

At least a portion of the functionality of the various elements in FIG. 5 may be performed by other elements in FIG. 5, or an entity (e.g., processor, web service, server, application program, computing device, etc.) not shown in FIG. 5.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

Alternatively, or in addition to the other examples described herein, examples include any combination of the following:

A system for recovering network connectivity comprising:

a first network interface;

a second network interface;

at least one processor; and

at least one memory comprising computer program code, the at least one memory and the computer program code configured to, with the at least one processor, cause the at least one processor to:

detect an acknowledgement failure for a connection using a first route over the first network interface;

in response to detecting the acknowledgement failure, increment a suspect reachability count of a path associated with the connection;

identify a second route over the second network interface as an alternative to the first route when the suspect reachability count of the path exceeds a suspect reachability threshold;

increment an unreachable path count of the first route based on the identified second route;

mark the first route as dead when a sum of the unreachable path count of the first route and a moved path count of the first route exceeds a bad path threshold, the bad path threshold based on a total path count of the first route; and

transition the connection using the first route over the first network interface to use the second route over the second network interface.

The system described above, wherein the total path count of the first route is based on paths associated with first route for which acknowledgements have been received.

The system described above, wherein the total path count and the unreachable path count are calculated based on active paths.

The system described above, the at least one memory and the computer program code configured to, with the at least one processor, further cause the at least one processor to:

detect an acknowledgement for the connection when the connection is using the first route over the first network interface;

set the suspect reachability count of the path associated with the connection to zero;

set the moved path count of the first route to zero; and

set the unreachable path count of the first route to zero.

The system described above, the at least one memory and the computer program code configured to, with the at least one processor, further cause the at least one processor to:

probe the first route at defined probe intervals when the first route is marked as dead, the probe including routing new connection attempts over the first route, the new connection attempts limited to a maximum probe connection threshold; and

mark the first route as alive when at least one new connection attempt over the first route receives an acknowledgement.

The system described above, wherein the new connection attempts are routed over the second route in parallel to being routed over the first route.

The system described above, wherein transitioning the connection using the first route over the first network interface to use the second route over the second network interface includes sending an abort notification to an application associated with the connection, such that the connection is retried on the second route over the second network interface.

The system described above, wherein identifying a second route over the second network interface as an alternative to the first route when the suspect reachability count of the path exceeds a suspect reachability threshold further includes identifying a second route over the second network interface as an alternative to the first route when the suspect reachability count of the path exceeds a suspect reachability threshold within a defined time interval.

The system described above, wherein the first network interface is a Wi-Fi network interface and the second network interface is a cellular network interface.

A computerized method for recovering network connectivity comprising:
detecting an acknowledgement failure for a connection using a first route over a first network interface;
in response to detecting the acknowledgement failure, incrementing a suspect reachability count of a path associated with the connection;
identifying a second route as an alternative to the first route when the suspect reachability count of the path exceeds a suspect reachability threshold;
moving the path to the identified second route and incrementing a moved path count of the first route when the identified second route is over the first network interface;
incrementing an unreachable path count of the first route when the identified second route is over a second network interface;
marking the first route as dead when a sum of the unreachable path count of the first route and the moved path count of the first route exceeds a bad path threshold, the bad path threshold based on a total path count associated with the first route; and
transitioning the connection using the first route over the first network interface to use the second route when the second route is over the second network interface.

The computerized method described above, wherein the total path count of the first route is based on paths associated with first route for which acknowledgements have been received.

The computerized method described above, wherein the total path count of the first route is based on paths associated with the first route that have been active within a first time interval, the suspect reachability count is based on acknowledgement failures within a second time interval, and the unreachable path count is based on unreachable paths identified within a third time interval.

The computerized method described above, further comprising:
detecting an acknowledgement for the connection when the connection is using the first route over the first network interface;
setting the suspect reachability count of the path associated with the connection to zero;
setting the moved path count of the first route to zero; and
setting the unreachable path count of the first route to zero.

The computerized method described above, wherein transitioning the connection using the first route over the first network interface to use the second route over the second network interface includes sending an abort notification to an application associated with the connection, such that the connection is retried on the second route over the second network interface.

The computerized method described above, wherein identifying a second route over the second network interface as an alternative to the first route when the suspect reachability count of the path exceeds a suspect reachability threshold further includes identifying a second route over the second network interface as an alternative to the first route when the suspect reachability count of the path exceeds a suspect reachability threshold within a defined time interval.

The computerized method described above, wherein the bad path threshold includes a percentage threshold of the sum of the unreachable path count of the first route and the moved path count of the first route as a percentage of the total path count associated with the first route; and wherein the percentage threshold varies based on the total path count associated with the first route.

One or more computer storage media having computer-executable instructions for recovering network connectivity that, upon execution by a processor, cause the processor to at least:
detect a failure of a connection using a first route over a first network interface;
in response to detecting the failure, increment a suspect reachability count of a path associated with the connection;
identify a second route over a second network interface as an alternative to the first route when the suspect reachability count of the path exceeds a suspect reachability threshold;
increment an unreachable path count of the first route based on the identified second route;
mark the first route as dead when a sum of the unreachable path count of the first route and a moved path count of the first route exceeds a bad path threshold, the bad path threshold based on a total path count associated with the first route; and
transition the connection using the first route over the first network interface to use the second route over the second network interface.

The one or more computer storage media described above, wherein the connection is based on a connection-oriented protocol.

The one or more computer storage media described above, wherein the total path count of the first route is based on paths associated with first route for which acknowledgements have been received.

The one or more computer storage media described above, wherein the total path count of the first route is based on paths associated with the first route that have been active within a defined time interval.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for identifying and/or detecting dead routes and/or gateways and transitioning network connections to alternative routes and/or network interfaces as a result. The illustrated one or more processors 519 together with the computer program code stored in memory 522 constitute exemplary processing means for detecting dead routes and/or gateways and switching to alternative routes and/or gateways on alternative interfaces.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The detailed description provided herein in connection with the appended drawings is intended as a description of a number of embodiments and is not intended to represent the only forms in which the embodiments may be constructed, implemented, or utilized. Although the embodiments may be described and illustrated herein as being implemented in devices such as a server, personal computer, mobile device, or the like, this is only an exemplary implementation and not a limitation. As those skilled in the art will appreciate, the present embodiments are suitable for application in a variety of different types of computing devices, for example, PCs, servers, laptop computers, tablet computers, etc.

The terms ‘computer’, ‘computing apparatus’, ‘mobile device’ and the like are used herein to refer to any device with processing capability such that it can execute instructions. Those skilled in the art will realize that such processing capabilities are incorporated into many different devices and therefore the terms ‘computer’ and ‘computing apparatus’ each may include PCs, servers, laptop computers, mobile telephones (including smart phones), tablet computers, media players, games consoles, personal digital assistants, and many other devices.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for recovering network connectivity comprising:
a first network interface;
a second network interface;
at least one processor; and
at least one memory comprising computer program code, the at least one memory and the computer program code configured to, with the at least one processor, cause the at least one processor to:
detect an acknowledgement failure for a connection using a first route over the first network interface;
in response to detecting the acknowledgement failure, increment a suspect reachability count of a path associated with the connection;
identify a second route over the second network interface as an alternative to the first route when the suspect reachability count of the path exceeds a suspect reachability threshold;
increment an unreachable path count of the first route based on the identified second route;
mark the first route as dead when a sum of the unreachable path count of the first route and a moved path count of the first route exceeds a bad path threshold, the bad path threshold based on a total path count of the first route; and
in response to marking the first route as dead, transition the connection from the first route over the first network interface to the second route over the second network interface.

2. The system of claim 1, wherein transitioning the connection comprises terminating the connection, and wherein the total path count of the first route is based on paths associated with first route for which acknowledgements have been received.

3. The system of claim 1, the at least one memory and the computer program code configured to, with the at least one processor, further cause the at least one processor to detect active paths, wherein the total path count and the unreachable path count are calculated based on the detected active paths.

4. The system of claim 1, the at least one memory and the computer program code configured to, with the at least one processor, further cause the at least one processor to:
detect an acknowledgement for the connection when the connection is using the first route over the first network interface;
set the suspect reachability count of the path associated with the connection to zero;
set the moved path count of the first route to zero; and
set the unreachable path count of the first route to zero.

5. The system of claim 1, the at least one memory and the computer program code configured to, with the at least one processor, further cause the at least one processor to:
probe the first route at defined probe intervals when the first route is marked as dead, the probe including routing new connection attempts over the first route, the new connection attempts limited to a maximum probe connection threshold; and
mark the first route as alive when at least one new connection attempt over the first route receives an acknowledgement.

6. The system of claim 5, wherein the new connection attempts are routed over the second route in parallel to being routed over the first route.

7. The system of claim 1, wherein transitioning the connection using the first route over the first network interface to use the second route over the second network interface includes sending an abort notification to an application associated with the connection, such that the connection is retried on the second route over the second network interface.

8. The system of claim 1, wherein identifying a second route over the second network interface as an alternative to the first route when the suspect reachability count of the path exceeds a suspect reachability threshold further includes identifying a second route over the second network interface as an alternative to the first route when the suspect reachability count of the path exceeds a suspect reachability threshold within a defined time interval.

9. The system of claim 1, wherein the first network interface is a Wi-Fi network interface and the second network interface is a cellular network interface.

10. A computerized method for recovering network connectivity comprising:
detecting an acknowledgement failure for a connection using a first route over a first network interface;
in response to detecting the acknowledgement failure, incrementing a suspect reachability count of a path associated with the connection;
identifying a second route as an alternative to the first route when the suspect reachability count of the path exceeds a suspect reachability threshold;
moving the path to the identified second route and incrementing a moved path count of the first route when the identified second route is over the first network interface;
incrementing an unreachable path count of the first route when the identified second route is over a second network interface;
marking the first route as dead when a sum of the unreachable path count of the first route and the moved path count of the first route exceeds a bad path threshold, the bad path threshold based on a total path count associated with the first route; and
transitioning, based on the marking, the connection using the first route over the first network interface to use the second route when the second route is over the second network interface.

11. The computerized method of claim 10, wherein the total path count of the first route is based on paths associated with first route for which acknowledgements have been received.

12. The computerized method of claim 10, wherein the total path count of the first route is based on paths associated with the first route that have been active within a first time interval, the suspect reachability count is based on acknowledgement failures within a second time interval, and the unreachable path count is based on unreachable paths identified within a third time interval.

13. The computerized method of claim 10, further comprising:
detecting an acknowledgement for the connection when the connection is using the first route over the first network interface;
setting the suspect reachability count of the path associated with the connection to zero;
setting the moved path count of the first route to zero; and
setting the unreachable path count of the first route to zero.

14. The computerized method of claim 10, wherein transitioning the connection using the first route over the first network interface to use the second route over the second network interface includes sending an abort notification to an application associated with the connection, such that the connection is retried on the second route over the second network interface.

15. The computerized method of claim 10, wherein identifying a second route over the second network interface as an alternative to the first route when the suspect reachability count of the path exceeds a suspect reachability threshold further includes identifying a second route over the second network interface as an alternative to the first route when the suspect reachability count of the path exceeds a suspect reachability threshold within a defined time interval.

16. The computerized method of claim 10, wherein the bad path threshold includes a percentage threshold of the sum of the unreachable path count of the first route and the moved path count of the first route as a percentage of the total path count associated with the first route; and
wherein the percentage threshold varies based on the total path count associated with the first route.

17. One or more computer storage media having computer-executable instructions for recovering network connectivity that, upon execution by a processor, cause the processor to at least:
detect a failure of a connection using a first route over a first network interface;
in response to detecting the failure, increment a suspect reachability count of a path associated with the connection;
identify a second route over a second network interface as an alternative to the first route when the suspect reachability count of the path exceeds a suspect reachability threshold;
increment an unreachable path count of the first route based on the identified second route;
mark the first route as dead when a sum of the unreachable path count of the first route and a moved path count of the first route exceeds a bad path threshold, the bad path threshold based on a total path count associated with the first route; and
transition the connection, in response to marking the first route as dead, from the first route over the first network interface to the second route over the second network interface.

18. The one or more computer storage media of claim 17, wherein the connection is based on a connection-oriented protocol.

19. The one or more computer storage media of claim 17, wherein the total path count of the first route is based on paths associated with first route for which acknowledgements have been received.

20. The one or more computer storage media of claim 17, wherein the total path count of the first route is based on paths associated with the first route that have been active within a defined time interval.
